(19) United States
(12) Patent Application Publication
(10) Pub. No.: US 2006/0067481 A1
(43) Pub. Date: Mar. 30, 2006

(54) Radiation collimation

(75) Inventor: Edward Morton, Surrey (GB)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: The University of Surrey, Guildford (GB)

(21) Appl. No.: 10/521,483

(22) PCT Filed: Jul. 21, 2003
(86) PCT No.: PCT/GB03/03276

§ 371 Date: Jul. 20, 2005

(30) Foreign Application Priority Data
Jul. 20, 2002 (GB) 0216891.2

(51) Int. Cl. G21K 1/04

(52) U.S. Cl. 378/151

(57) ABSTRACT

In a collimator assembly for an X-ray imaging system comprising adjustable X-ray attenuating collimator vanes that define the area of a patient to be exposed to an X-ray beam, the collimator vanes (1, 2, 3, 4) are automatically driven under the control of an image processing apparatus to attenuate the X-ray beam to form exposure fields (5) of chosen shape.

This invention relates to a collimator for use in radiation collimation. It is particularly concerned with collimation of radiation employed in X-ray fluoroscopy.

X-ray fluoroscopy is a commonly used procedure for guiding interventional procedures within the body, or for visualising the structure/function of internal organs in the body. It is characterised by the use of X-ray imaging at video rate (normally 6 to 30 frames per second).

Conventionally, an X-ray imaging system for fluoroscopy comprises an X-ray irradiation unit (for example an X-ray tube and generator, collimator assembly, beam filter(s) and light beam diaphragm) combined with an imaging chain (for example, an X-ray image intensifier, lens system with optical iris, video camera, image processor and monitors). The images are observed by one or more specialist clinicians.

Typical clinical applications of fluoroscopy include interventional neuroradiology, cardiology and peripheral vascular angiography. These are all techniques involving a high degree of risk of harm to a patient and thus require extremely careful control of instruments such as catheters to be inserted into the patient. In particular it is highly desirable that the X-ray images presented to clinicians operating the applications should be very clear in indicating the detail of the part of the body under investigation and in showing the precise location of inserted instruments.

A related problem is however that prolonged exposure to X-ray irradiation poses in itself a health risk, especially to the patient undergoing treatment, but also to the clinicians conducting the treatment. Although the dose received by the clinicians at an individual treatment may be relatively small, their repeated exposure in treatment of successive patients adds to a total level of irradiation which places an upper limit on the number of treatments they can conduct. It is therefore desirable that the exposure to radiation should be kept to a minimum.

Our two co-pending patent applications of even date disclose means to reduce X-ray dosage levels, in the one case by carefully controlled imaging to limit high radiation exposure to areas that essentially need it and in the other case by applying colour highlighting to hasten a clinician's perception of a displayed image so as to facilitate rapid responsive actions.

The present invention addresses the dose problem by improvements to collimators used in an X-ray imaging system.

Collimators are well known components of imaging apparatus and many prior proposals have been made for their configuration and operating features.

A typical X-ray imaging system comprises a collimator assembly comprising two pairs of opposing, X-ray attenuating, collimator pieces (vanes) that may be driven under manual control to define the area of the patient that is exposed by X-radiation. Each of the collimator vanes in a pair is held orthogonal to the other. Normally, these collimating vanes are driven symmetrically about the centre of the assembly. This allows the operator to define an arbitrarily sized rectangular field for exposure of the patient. In all known practical systems, the collimator vanes are opaque to X-radiation.

Some prior proposals have been made to provide a measure of automation in the positioning of collimator vanes. U.S. Pat. No. 5,253,169 proposes the use of a collimator which moves according to the location of a monitored catheter tip, but gives no details of the necessary hardware nor of any filtering function for controlling the system. U.S. Pat. No. 5,278,887 proposes the use of semitransparent collimators that move automatically in response to a “medical instrument” but it gives no details of the control strategy.

The present invention has as the objective of providing an adjustable collimator assembly that may be used in conjunction with an image processing apparatus in order to control automatically the X-ray exposure to a patient and thereby permit the X-ray dose to be minimised.

According to the present invention there is provided a collimator assembly for an X-ray imaging system comprising adjustable X-ray attenuating collimator vanes that define the area of a patient to be exposed to an X-ray beam, characterised in that the collimator vanes are automatically driven under the control of an image processing apparatus to attenuate the X-ray beam to form exposure fields of chosen shape.

A particular advantage of the invention is that the automatically driven collimator is able to form exposed X-ray fields of a wide variety of shapes and sizes, and is therefore not limited to the traditional rectangular shapes. This means that the shape can be closely matched to the precise area requiring observation. Moreover by forming the shape under the control of an image processing apparatus an optimal shape can be formed quickly, which therefore further limits the extent of exposure.

The collimator of the invention may be used alone but is preferably used in combination with a standard manually driven collimator which employs opaque collimator vanes to provide rectangular exposure fields.

In this preferred combination mode, which is the mode to which most of the present description relates, the collimator according to the invention represents the second collimator in the imaging system.

The collimator vanes of the present invention (the “second collimator”) an be chosen from a wide variety of properties, with a range of X-ray attenuating properties. Thus their X-ray transmission profile may be: uniform and opaque; partially transparent with uniform transmission; partially transparent width a linear wedge shaped transmission profile; partially transparent with an exponential transmission profile; partially transparent with a parabolic transmission profile; or partially transparent with an arbitrary transmission profile.

It is normally preferred for a partially transparent collimator vane to be most transparent towards the centre of the X-ray field and least transparent at the edge of the X-ray field. A partially transparent collimator vane may be opaque either at the periphery, or within the normally exposed region, of the radiation field.

A uniform, partially transparent collimator vane will typically have an X-ray transmission of 2 to 10% of the normal intensity.

A wide variety of shapes and materials can be used according to the invention as the collimator vanes. For example they may be arranged in two sets of opposing pairs of flat opaque material; made from flexible attenuaiing material such as lead rubber; formed of “slats” of attenuating material which draw over each other; or multiple opposing collimator vanes, which may have a uniform or varying transmission profile. In a vane structure, each vane preferably has an edge profile which ensures that no gaps of high X-ray transmission appear between the vanes as they are moved.

A version of collimator comprising multiple vanes, each of which may be extended into the radiation field independently of all the others, may typically include two sets of parallel vanes, with for example 8 to 20 vanes in each set, and the sets being in opposed positions on each side of the radiation field. The vanes may have a uniform or varying transmission profile.

Flexible vanes may be wrapped around respective cylindrical formers to reduce the space they occupy alongside the radiation field.

Each collimator vane preferably has an individual drive means to move it independently of other vanes, thereby allowing exposure of regions that do not lie in the centre of the image field. Each vane is also preferably under mechanical tension, for example by spring-loading, so that it must be actively driven to move across the radiation field. Thus if a drive signal is removed, or electrical power to the collimator is lost, the mechanical tension immediately pulls the vanes out of the active radiation field.

The drive means may for example comprise a wire drive and pulleys under the control of a d.c. or stepping motor. Alternatively the drive means may comprise a linear actuator or solenoid. The drive means may further comprise a mechanical clutch which may be used to couple mechanical power from the motor to the pulleys. By disengaging the clutch, the collimator vanes rapidly withdraw under the mechanical tension from the exposed region.

An encoder may be fitted to the cylindrical formers to ensure accurate positioning of the collimator vanes in the radiation field.

Additional guide rails, limit switches and other relevant fixtures may be provided as required to secure and guide the vanes in the desired positions. Further, linear servo mechanisms or other drive systems may be used in place of pulley drive systems as appropriate.

In a preferred embodiment of the invention, the entire second collimator assembly may be rotated about the centre of the radiation field. This may be achieved by driving a circular gear surrounding the periphery of the radiation field by a cog attached to a suitable motor. An encoder is used to determine the collimator rotation angle. This allows a greater range of field shapes to be generated (e.g. diamond as well as square). Normally, the mechanical components of the assembly rotate within a non-rotating housing that also encloses suitable electronics circuits and power supplies. Signals to the rotating electronic components (e.g. motors, encoders, limit switches, clutches) may be supplied either through a cable loop or via slip-rings.

In a further refinement of the second collimator assembly, each collimator vane may be driven independently to arbitrary angles. This allows field shapes such as parallelepipeds to be generated in addition to squares and diamonds.

In a further embodiment of the invention the second collimator comprises an iris assembly created from a plurality of X-ray attenuating vanes that are each rotatable about a point located outside of the normally exposed radiation field. By adjusting the angle of rotation of each vane, a circular region of normal X-ray transmission can be formed, surrounded by a region of reduced X-ray transmission. Each X-ray attenuating vane may have a constant or varying X-ray transmission profile.

In a refinement of this second collimator assembly, the position of the centre of the exposed region may be moved across the image area, so allowing the high exposure region to be located at the centre of the region of interest in the X-ray image.

Regardless of the mechanical configuration of the second collimator assembly, there is required an electronic circuit to control, power and monitor the position of the individual mechanical components within the collimator. Typically this circuit will contain at least one microprocessor. The electronic circuit communicates with the image processing assembly. Typically this is achieved through a serial data link. By modulating the power supply lines with the digital control and response signals, it is possible to minimise the number of connections between the image processing assembly and the second collimator electronics.

Normally, the second collimator electronics will receive instructions to, for example, set a collimator variable such as position of a vane. The electronic circuit will read the value of the relevant encoder and drive the motor or other actuator until the value indicated by the encoder matches the set value. It is common to return an acknowledgement to indicate that the set value has been reached. Alternatively, the second collimator electronics may receive an instruction to return the current position value of a particular variable, or set of variables. In this case, each appropriate value is returned as part of the instruction acknowledgement sequence.

For all automatic collimator designs, collision control software is required as part of the collimator electronics. Current sensing electronics can be implemented for all collimator drive motors or actuators to feed into the collision control algorithms. For example, if unexpectedly high current is being drawn by a pair of motors, it is likely that they are driving against each other following a collision.

The invention is further described, in a non-limiting manner, with reference to the accompanying figures, in which:

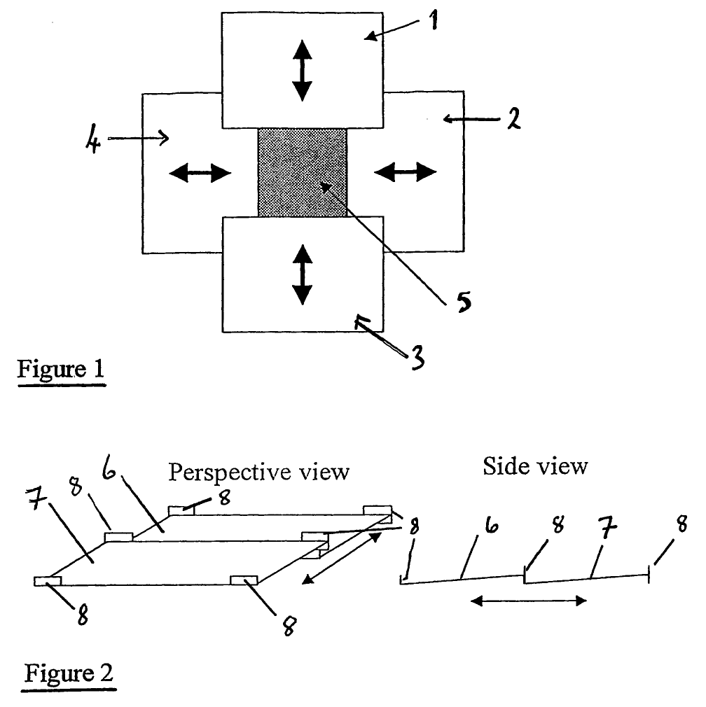

FIG. 1 is a diagrammatic plan view of a second collimator assembly according to the invention;

FIG. 2 shows both a diagrammatic perspective view and diagrammatic side view of two slats for use in an assembly such as that of FIG. 1;

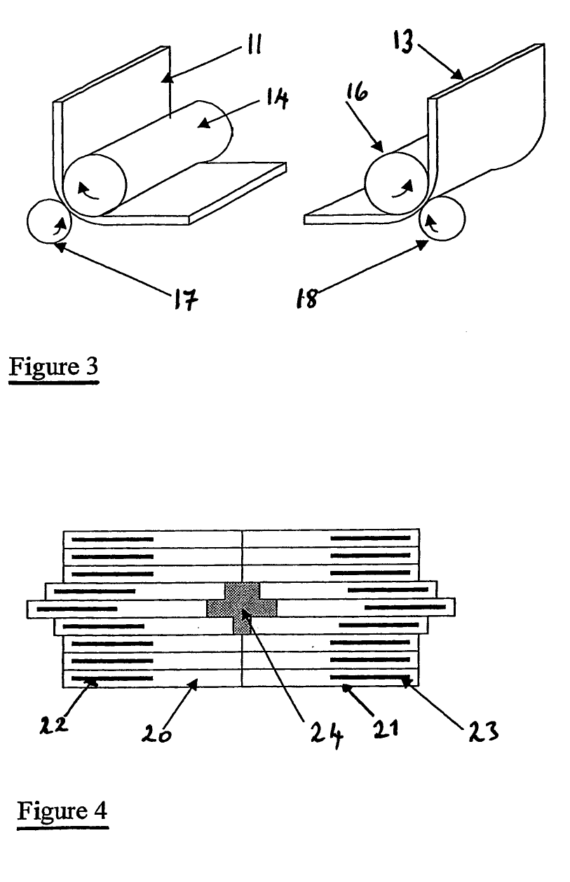

FIG. 3 shows a diagrammatic perspective view of a further type of collimator according to the invention.

FIG. 4 shows a plan view of a multiple vane collimator according to the invention.

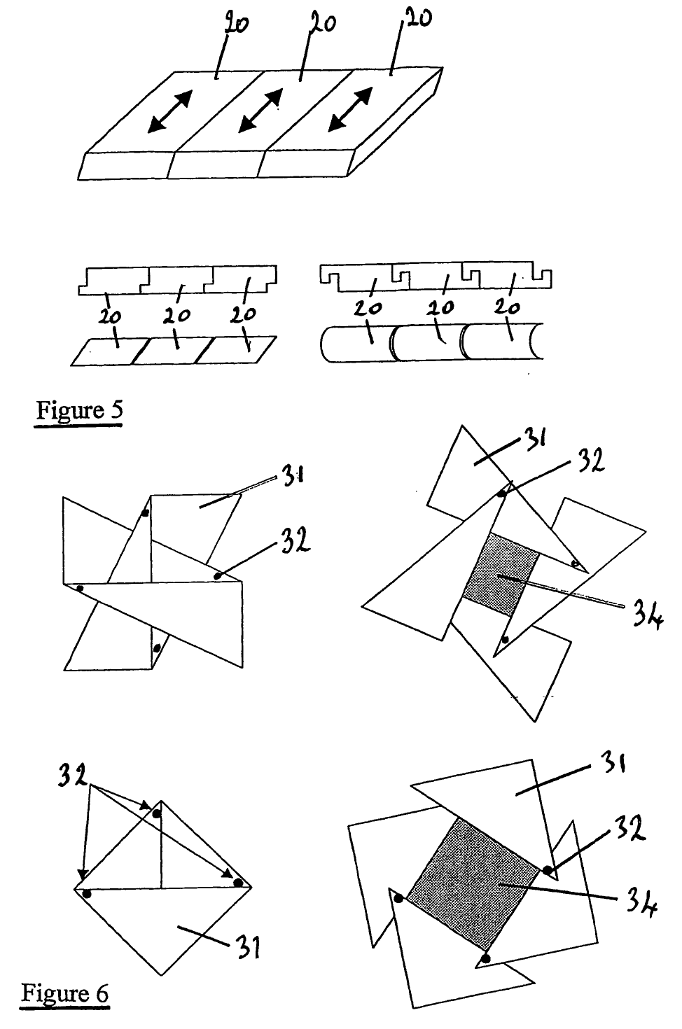

FIG. 5 shows four different types of edge profile for collimator vanes according to the invention.

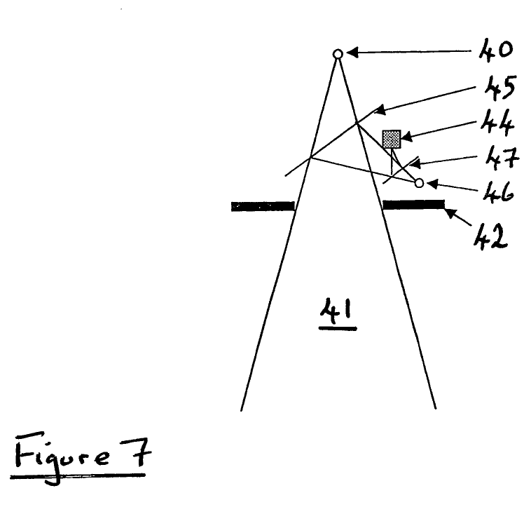

FIG. 6 shows two further versions of collimator according to the invention, each being shown in both the open and shut positions.

FIG. 7 is a diagrammatic view of an imaging system suitable for use with a collimator according to the invention.

The second collimator assembly shown in FIG. 1 comprises four collimator vanes, 1, 2, 3, 4, arranged in two pairs (1,3 and 2,4) beneath an X-ray source (not shown in FIG. 1) to define an exposure field 5. Each collimator vane (1-4) has a drive means (not shown) to move it independently of the other three, thereby allowing exposure of regions that do not lie in the centre of the image field.

Each collimator vane 1-4 is under spring loaded mechanical tensions so that it must be actively driven to move across the radiation field. If the drive signal is removed, or electrical power to the collimator is lost, the mechanical tension immediately pulls the vanes 1-4 out of the active radiation field.

The version of collimator shown in FIG. 2 comprises two collimator vanes 6, 7 made from “slats” of attenuating material which draw over each other. The slats 6,7 include ridge plates 8 arranged at their ends to ensure that they are mechanically positioned such that attenuation of the transmitted X-ray beam appears uniform over the entire collimator vane. The leading slat (i.e. the one closest to the centre of the radiation field) is fixed to a motor-driven pulley drive system (not shown) including a mechanical clutch. A spring assembly is fixed to the pulley drive to withdraw the collimator vane from the radiation field as required.

FIG. 3 shows a version of collimator vane formed from flexible lead rubber and illustrates just two opposing vanes, 11,13. These are wrapped around respective cylindrical formers 14, 16 and driven across the radiation field via a motor-driven wire drive, which incorporates a mechanical clutch, and pulleys 17, 18. Springs (not shown) are attached to the collimator housing and to each of the cylindrical formers 14,16 such that the springs are tensioned when the collimator vanes 11, 13 are unwrapped. By disengaging the clutch, the collimator vanes 11, 13 rapidly withdraw from the exposed region field. An encoder (not shown) is fitted to the cylindrical formers 14, 16 to ensure accurate positioning of the collimator vanes 13, 14 in the radiation field.

The version of collimator shown in FIG. 4 comprises multiple opposing collimator vanes 20 and 21 arranged in opposing sets of nine parallel rigid vanes, each vane being independently adjustable so that collectively they define the radiation field 24. Each vane 20, 21 comprises a guide slot 22, 23 to engage a peg (not shown) to ensure precise parallel movement.

FIG. 5 illustrates different versions of edge profile for the vanes of FIG. 4: bevelled; L-shaped; S-shaped; and curved. In each case the requirement for the profile is to ensure that no gaps of high X-ray transmission appear between the vanes as they are moved.

Further versions of the second collimator assembly are shown in FIG. 6. In these versions, an iris assembly is created from a number of triangular attenuating vanes 31 that are each rotatable about points 32 located outside of the normally exposed radiation field 34. Collectively the vanes 31 define the said field, which by appropriate selection of the number, shape and angle and point of rotation can vary from square through polygonal to circular.

A particular advantage of the collimators shown in FIGS. 4 and 6 is the facilty with which the exposed filed can be moved relative to the surface of the patient in order to track the filed of interest.

Each X-ray attenuating vane may have a constant or varying X-ray transmission profile. By having a variable transmission profile, a region of reduced X-ray transmission can be formed around the region of normal X-ray transmission.

In the operation of any device that controls the irradiation of a patient, it is essential to verify that the set position of the collimator is matched by its true position. In the case of X-ray fluoroscopy, this may be achieved in two ways:

In the first example, the X-ray image projected onto the X-ray image receptor will be a result of the combined collimation of the first and second collimators. When the area enclosed by the second collimator is smaller than the area defined by the first collimator, it is possible to locate the position of the second collimator in the measure X-ray image. To do this, it is normal for the image processing apparatus to be able to detect the collimator edges automatically.

The second example is illustrated with reference to FIG. 7, which shows an X-ray source 40 which transmits an X-ray beam 41 through a collimator 42. A television camera 44 views the collimator 42 setting via a front surface mirror 45, normally used to propagate light from a source 46 through the collimator 42, to observe the set field size on the surface of the patient. This is conventionally called the light beam diaphragm. The camera 44 observes the patient via a beam splitter 47 in the optical path. Images from this camera 44 are fed to image processing apparatus which can then segment the image to locate automatically the positions of the collimator vanes.

In either case, if an unexpected difference is determined between the set position and actual position, appropriate remedial action can be taken.

1. A collimator assembly for an X-ray imaging system comprising adjustable X-ray attenuating collimator vanes arranged to define an area of a patient to be exposed to an X-ray beam, and an image processing apparatus arranged to automatically control driving the collimator vanes to attenuate the X-ray beam to form exposure fields of chosen shape.

2-22. (canceled)

23. An assembly as claimed in claim 1, which comprises a combination of a first manually driven collimator, which employs opaque collimator vanes arranged to provide rectangular exposure fields, and a second collimator comprising the automatically-driven collimator.

24. An assembly as claimed in claim 1, in which the collimator vanes have an X-ray transmission profile selected from: uniform and opaque; partially transparent with uniform transmission; partially transparent width a linear wedge shaped transmission profile; partially transparent with an exponential transmission profile; partially transparent with a parabolic transmission profile; and partially transparent with an arbitrary transmission profile.

25. An assembly as claimed in claim 1, in which the X-ray exposure field has a centre and an edge, wherein the vanes comprise partially transparent collimator vanes which are most transparent towards the centre of the X-ray field and least transparent at the edge of the X-ray field.

26. An assembly as claimed in claim 1, in which the radiation field has a periphery and a normally exposed region, the vanes comprising a partially transparent collimator vane which is opaque at the periphery, or within the normally exposed region, of the radiation field.

27. An assembly as claimed in claim 1, wherein the vanes are partially transparent collimator vanes having an X-ray transmission wherein the X-ray transmission is of 2 to 10% of the normal intensity.

28. An assembly as claimed in claim 1, wherein the vanes are arranged in collimator vane configurations selected from: two sets of opposing pairs of flat opaque material; flexible attenuating material such as lead rubber; slats of attenuating material arranged to draw over each other; and multiple opposing collimator vanes.

29. An assembly as claimed in claim 1, wherein the vanes have an edge profile arranged such that no gaps of high X-ray transmission appear between the vanes as they are moved.

30. An assembly as claimed in claim 1, wherein, each vane is extendable into the radiation field independently of all the others.

31. An assembly as claimed in claim 30, in which the radiation field has sides, wherein the vanes comprise two sets of parallel vanes and each set comprises 8 to 20 vanes, the sets being in opposed positions on each side of the radiation field.

32. An assembly as claimed in claim 1, in which the vanes of the automatically driven collimator have a transmission profile, wherein the profile is a varying transmission profile.

33. An assembly as claimed in claim 1 further comprising, an individual drive means associated with each of the vanes of the automatically driven collimator arranged to move the vane independently of other vanes.

34. An assembly as claimed in claim 33, comprising one of a d.c. motor and a stepping motor in which the drive means comprises a wire drive and pulleys under the control of the motor.

35. An assembly as claimed in claim 34, in which the drive means includes a mechanical clutch arranged to couple mechanical power from the motor to the pulleys.

36. An assembly as claimed in claim 33, in which the drive means comprises one of a linear actuator and a solenoid.

37. An assembly as claimed in claim 1, in which each of the vanes of the automatically driven collimator is under mechanical tension so that it must be actively driven to move across the radiation field.

38. An assembly as claimed in claim 37, in which the mechanical tension is provided by spring-loading.

39. An assembly as claimed in claim 1, further comprising an encoder arranged to ensure accurate positioning of the vanes relative to the radiation field.

40. An assembly as claimed in claim 1, wherein the radiation field has a centre and the automatically driven collimator forms part of an assembly which is rotatable about the centre of the radiation field.

41. An assembly as claimed in claim 40, in which the radiation field has a periphery and the assembly further comprises a motor-driven cog and a circular gear wherein the cog and gear are arranged to surround the periphery of the radiation field and to rotate the assembly.

42. An assembly as claimed in claim 1, in which each vane is arranged to be driven independently to an arbitrary angle to allow field shapes selected from parallelepipeds, squares and diamonds.

43. An assembly as claimed in claim 1, which comprises an iris assembly created from the X-ray attenuating vanes which are each rotatable about points located outside of the normally exposed radiation field.

44. An assembly as claimed in claim 1, comprising individual mechanical components and an electronic circuit arranged to control, power and monitor the position of the individual mechanical components within the collimator.
